(19) United States
(12) Patent Application Publication
(10) Pub. No.: US 2011/0191209 A1
(43) Pub. Date: Aug. 4, 2011

(54) Method and System for Conditional Transactions

(75) Inventors: David A. Gould, Boulder, CO (US); Alec P. Karys, Framingham, MA (US)

(73) Assignee: 2B Wireless, Boulder, CO (US)

(21) Appl. No.: 12/854,874

(22) Filed: Aug. 11, 2010

Related U.S. Application Data
(63) Continuation-in-part of application No. 12/123,297, filed on May 19, 2008, now Pat. No. 7,877,297.
Application No. 12/123,297 is a continuation of application No. 11/340,046, filed on Jan. 26, 2006.
Application No. 12/123,297 is a continuation of application No. 11/601,135, filed on Nov. 17, 2006.
(60) Provisional application No. 60/938,972.
(60) Provisional application No. 61/015,188, filed on Dec. 19, 2007.
(60) Provisional application No. 60/647,363, filed on Jan. 26, 2005.

(51) Int. Cl. G06Q 30/00

(52) U.S. Cl. 705/26.82

(57) ABSTRACT

A method and system for conditional transactions (purchases/financial transactions) are provided. The system may include of these types of cards, to include but not limited to, credit, debit, gift, stored-value, charge, ATM or may use mobile devices with NFC in a swipe and go mode, or other types of mobile payment systems. The system provides one or more master accounts wherein each master account is tied to and control one or more subordinated accounts. Each subordinated account may have a configurable/customizable set of permissions defined by the master account. The subordinated account holder would optionally require permission from the master account holder to complete a purchase/financial transaction. The master account holder would have an extensible number of configurable/customizable permission rules to choose from for each subordinate account.

### PRIORITY CLAIM/CROSS-REFERENCE TO RELATED APPLICATIONS

This application claims priority under 35 USC 120 and is a continuation in part of U.S. patent application Ser. No. 12/123,297 filed on May 19, 2008 entitled “Method and System for Conditional Transactions” which in turn claims benefit under 35 USC 119(e) to U.S. Provisional Patent Application Nos. 60/938,972 filed on May 18, 2007 and entitled “Method and System for Conditional Transactions” and 61/015,186 filed on Dec. 19, 2007 and entitled “Method and System for Conditional Transactions” both of which are incorporated herein by reference. This application also claims priority under 35 USC 120 to U.S. patent application Ser. No. 11/340,046 filed on Jan. 26, 2006 entitled “Method and System for Transmitting Real-Time or Near Real Time Price Comparison and/or Product Information to Potential Consumers and For Facilitating Optional Fulfillment and Optional, Automated, Real-Time or Near Real-Time “Reverse Auctions Through Wireless or Wireline” which in turn claims the benefit from U.S. Provisional Patent Application No. 60/647,363, filed Jan. 26, 2005, entitled, “A Method and System for Transmitting Real-Time or Near Real Time Price Comparison and/or Product Information to Potential Consumers and Also Facilitating Real-Time or Near Real-Time “Reverse Auctions”, Purchase, Payment and Fulfillment Alternatives,” and U.S. patent application Ser. No. 11/601,135 filed on Nov. 17, 2006 entitled “Method and Apparatus for Encouraging Wireless Device Users to Send Marketing Messages Via a Wireless Communications Network”. All of the above identified provisional and utility patent applications are incorporated herein by reference.

### FIELD

A system and method for traditional brick and mortar (“in-store”) commerce, electronic commerce (e-commerce), mobile commerce (m-commerce), and financial institutions payments platforms, are disclosed.

### BACKGROUND

According to 2009 U.S. census estimates, approximately 20% of the U.S. population, more than 63 million people, are between the ages of 10 and 24. Recent surveys suggest that of these, less than 15% have access to their parents' electronic payment/transaction cards, to include credit cards, debit cards, gift cards, stored-value cards, charge cards, ATM (Automated Banking Machine) cards. At the same time, approximately $4 trillion is spent by U.S. consumers shopping and billions more are included in financial transactions of various types which include these types of electronic/payments cards. Of this amount, some research suggests that more than 50% is paid for using either credit cards, debit gift cards, stored-value cards or charge cards. Adding ATM cards would add considerably to the total volume of transactions made by these types of cards, (hereafter referred to “Electronic Payment/Transaction Media”). A majority of purchases/transactions are made using Electronic Payment/Transaction Media, often utilizing traditional Payment Gateways including Mobile Payment Gateways. At the same time, the majority of college students, teenagers and pre-teens do not have access to such cards. And so, there has been an ongoing intensifying debate amongst parents whether or not kids should be given access to Electronic Payment/Transaction Media. There are good reasons for this. Are kids emotionally ready for access to Electronic Payment/Transaction Media? Are they responsible enough to handle the financial implications that can dramatically impact their parents who are usually financially responsible for their purchases? And how do parents control their purchases? Regardless of debit, credit or stored value, once in the hands of kids, kids can usually make purchases without parent approval subject only to the credit or balance limitations associated with their Electronic Payment/Transaction Media. Additionally, there are issues of lost cards, credit exposure, identity theft and the other financial risks that make providing access to such payment solutions for kids a difficult decision. It might also be noted many spouses and domestic partners do have access to Electronic Payment/Transaction Media but lack the financial responsibility to control their spending against such Electronic Payment/Transaction Media. Finally, many corporations and even governments often issue Electronic Payment/Transaction Media to employees, recipients of unemployment benefits or other public assistance without any ability to control how, where or when such Electronic Payment/Transaction Media are utilized.

### BRIEF DESCRIPTION OF THE DRAWINGS

FIG. 1 shows a master workflow for a family plan system for an existing web site use case;

FIG. 2 is a diagram of a family plan system showing connections to customer communications devices and merchant servers;

FIG. 2A is a diagram of a family plan system showing connections to customer communications devices and merchant servers, including optional ATMs and in-store POS terminals;

FIG. 3 presents an illustration of a customer user interface which includes a potential Master Account user and a potential Sub Account user;

FIG. 4 presents an illustration of the Master Account creation screen;

FIG. 5 present an illustration of the Sub Account creation screens;

FIG. 6 presents an illustration of the order queue of conditional orders awaiting approval;

FIG. 7 presents an illustration of the “wish list” which contains rejected purchase requests;

FIG. 8 shows a licensee web site illustration;

FIG. 9 illustrates a check out path illustration, normal, approved and conditional;

FIG. 10 illustrates a credit card company screen for establishing Master Accounts;

FIG. 11 illustrates a credit card company screens for establishing Sub Accounts;

FIG. 12 shows a master account billing information;

FIG. 13 illustrates a licensee web site-Registration Form-Master Account Holder;

FIG. 14 illustrates a sub Account Holder-Flow at Licensee Web Site;

FIG. 15 illustrates a master Account Holder-Authorization and Denial Rules;

FIG. 16 illustrates sub account information; and

FIG. 17 illustrates a sub account check out Process.

FIG. 18 illustrates a Payment Gateway process.

### DETAILED DESCRIPTION OF ONE OR MORE EMBODIMENTS

The system and method are particularly applicable to an online ecommerce system implementation as described below and it is in this context that the system and method will be described. It will be appreciated, however, that the system and method has greater utility since it can be implemented in other manners than those described below, such as a totally mobile commerce system or an in person in store purchase, or an independently located ATM, or an ATM located physically at a financial institution. Furthermore the system modules may be deployed totally locally, totally remote, or in a hybrid model, where there is a partial local deployment and a partial remote deployment. This table further articulates such possibilities.

| | | | Hybrid with partial |
|---|---|---|---|
| | Total | Total Remote (in | deployment locally |
| | Local | Cloud or otherwise) | partial remoted |
| Merchant commerce | Yes | Yes | Yes |
| ecosystem | | | |
| Bank or Credit Card | Yes | Yes | Yes |
| Payments system | | | |

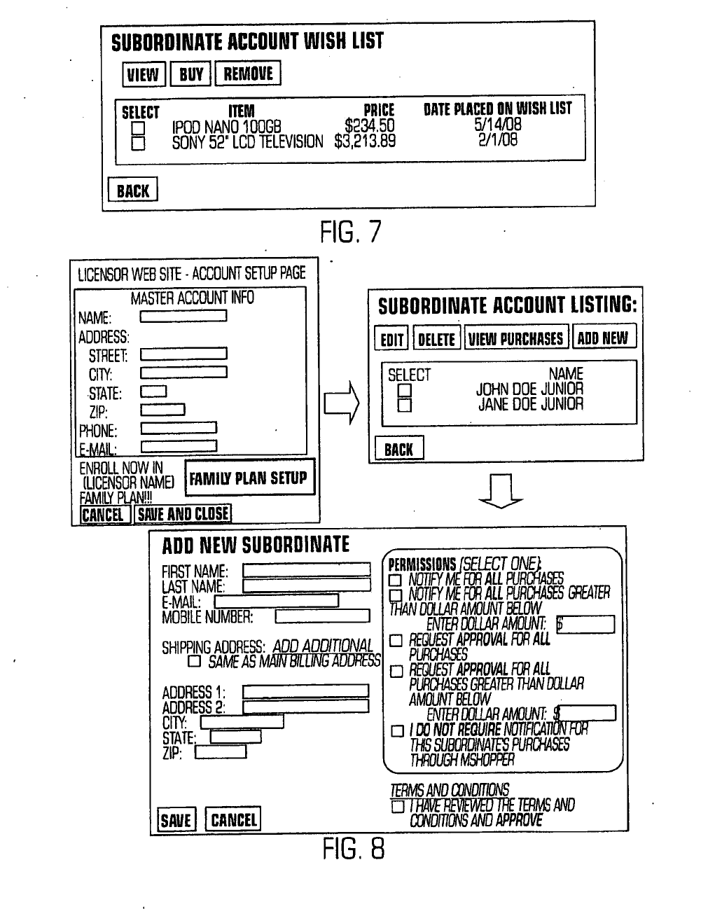

There is provided an end-to-end method and system that facilitates (i) the conditional purchase/transaction by Minor Dependents of any item they desire to purchase and/or financial transactions they desire to complete i.e. cash withdrawals from an ATM, (hereafter, the “Conditional Purchase/Transaction”), (ii) the real-time, near real-time and time delayed opportunity for parents or other legal guardians of such Minor Dependents who possess a credit, debit, stored value card, gift card, charge card or ATM card, (hereafter, the “Parent or Guardian”) to receive notification of an Conditional Purchase/Transaction by a Minor Dependent and to review certain aspects of the Conditional Purchase/Transaction including, but not limited to the product name, brand, model number, price, and merchant, (iii) the real time, near real time and time delayed opportunity for a Parent or Guardian to approve or disapprove of such Conditional Purchase/Transaction such that if the Conditional Purchase/Transaction may be approved by the Parent or Guardian, the Conditional Purchase/Transaction gets processed as approved and payment effectuated against the Electronic Payment Medium of such Parent or Guardian. The process can optionally provide the Minor Dependent with real time, near real time, or time delayed notification of the Parent or Guardian's decision to either approve of disapprove of the Conditional Purchase/Transaction. Disapproval of the Conditional Purchase/Transaction, can be provided for by the method and system to store all such disapproved Conditional Purchases/Transactions in a ‘wish list’ so that the Conditional Purchases/Transactions might be purchased/approved at a later date. An example of the user interface for the “wish list” is shown in FIG. 7.

Minor Dependents are provided an ability to make Conditional Purchases/Transactions in a context that is remote from immediate supervision of their Parent or Guardian while simultaneously providing to the Parent or Guardian the ability to monitor and control their Conditional Purchases/Transactions.

An operatively configured system that desires to take advantage of the method and system described herein may be referred to as a “Licensee”. Licensees may include, but are not limited to web-based e-Commerce sites, such as Amazon.com, and Walmart.com; online payment processors, such as Paypal, Paypal Pro, Google Checkout, and Chase Paymentech; cell phone company family plans, and major issuers of credit cards, such as American Express, Discover, Visa, Mastercard and Barclay's, as well as merchants, such as Nordstrom, Macy's etc. To facilitate Licensee adoption, an Open Application Programming Interface (API) is provided. This Open API would include all details required to initiate, complete and track a transaction and would include multiple levels of security to provide for authentication and validation.

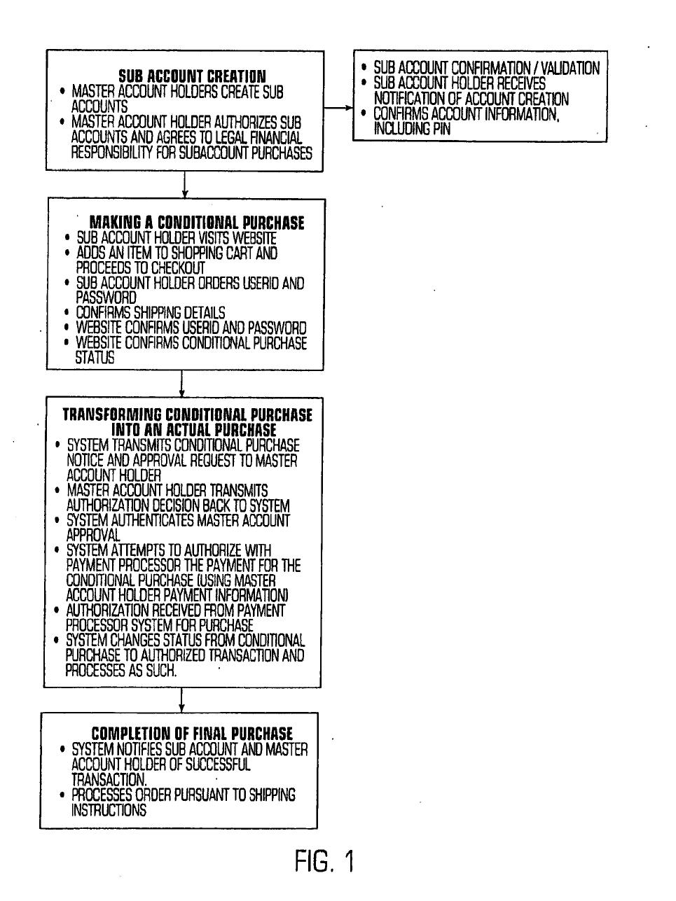

FIG. 1 illustrates a master workflow for a Conditional Purchase/Transaction system and method being performed within an existing web site/ecommerce site. The method may include the process of sub-account creation, sub-account confirmation and validation, making a conditional purchase, transforming a conditional purchase into an actual purchase and completion of the final purchase wherein details of each of these processes are shown in FIG. 1 and described below in more detail.

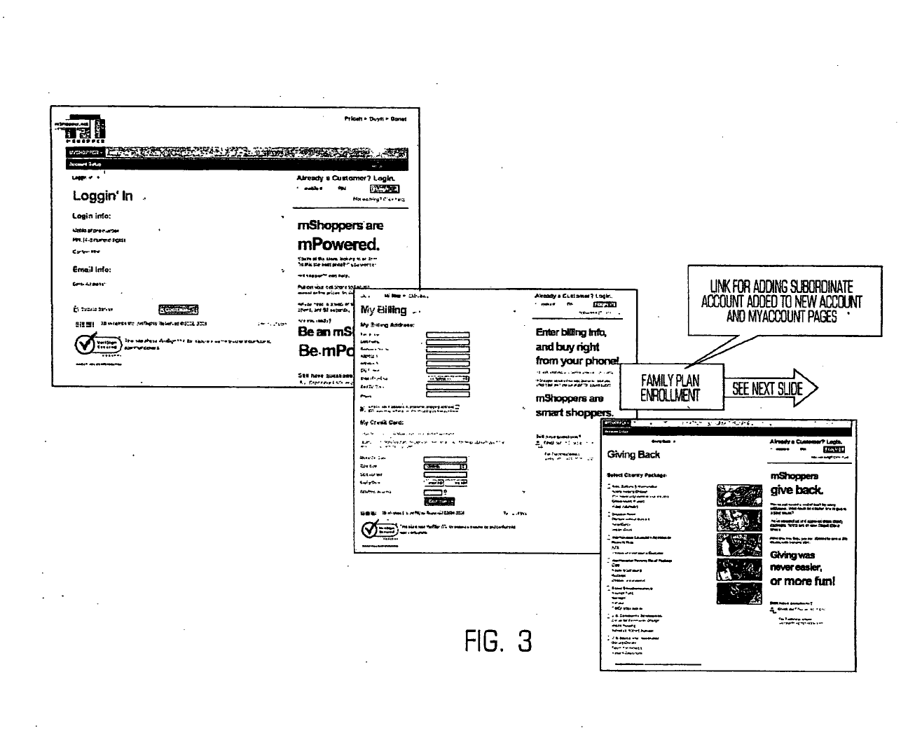

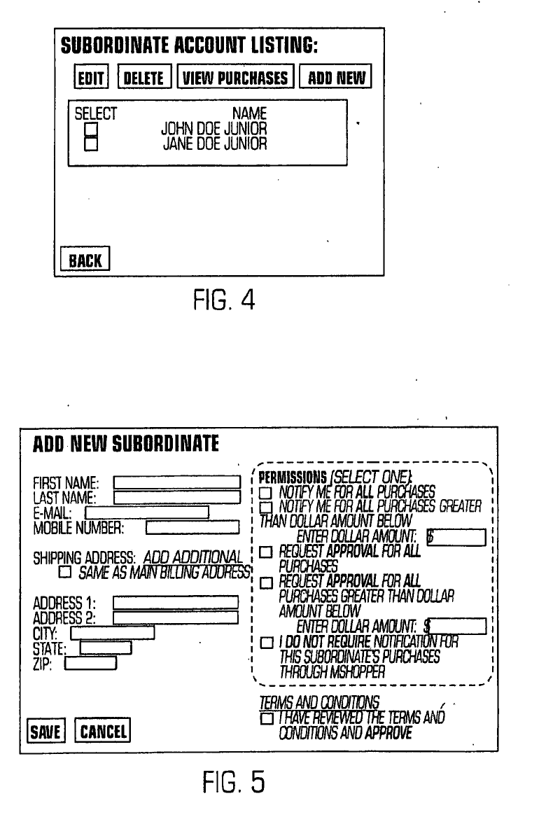

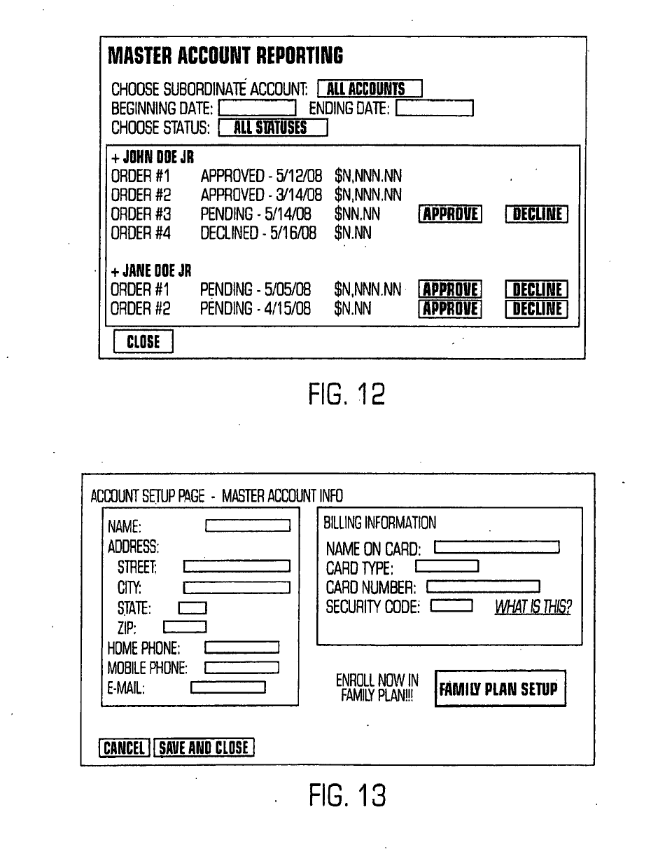

Creation of Sub Accounts by a Master Account Holder. As used hereafter, a Master Account is any standard user registration account that has been created by a Parent or Guardian with a Licensor. A Master Account Holder is anyone who has successfully created a Master Account. Typically, Licensors, such as Amazon.com, require users to register with their site. Moreover, many, if not most user accounts require basic information including demographic information, such as contact information which may comprise: name, address, phone numbers, cell phone numbers, and email addresses; security information, such as usernames, passwords, and personal identification numbers (PIN); and billing information, such as credit card number, debit card number, gift card number, name on card, billing address associated with the card, and card security numbers. This information may be referred to as the Master Account Billing Information. An example of the user interface showing the Master Account billing information is shown in FIG. 12. As contemplated herein, Master Accounts should include the Master Account Billing Information. If a Parent or Guardian visits a Licensor location or website and has not created a Master Account, then he should do so. Having created a Master Account with a Licensor, the Master Account Holder can be presented with an option to create one or more Sub Accounts associated with such Master Account. There is no limit to the number of Sub Accounts that may be created. A Sub Account may be linked to more than one Master Account. A Sub Account is a class of user account that is optionally created by the Master Account Holder. Sub Accounts may contain similar information as Master Accounts, including, but not limited to, the basic demographic information, contact information, security information, and optional shipping information. FIGS. 3-5 illustrates an example of a customer user interface for master accounts and sub-accounts (including a sub-account creation screen). Sub Accounts may differ from Master Accounts. They may not have their own unique payment information or Electronic Payment Media. The relationship between a Master Account and Sub-Account is that subject to the method and system described herein and further subject to the Master Account Holder's approval. Conditional Purchases made by Sub Account Holders are credited against the Master Account Billing Information associated with the Master Account Holder's Master Account

Visiting a Licensee website, a Master Account Holder can be notified of this new feature and prompted via standard hyperlinks, email, banner advertisements, or other medium to add Sub Accounts to his Master Account. An example of the Licensee web site with the Master Account set-up page, the subordinate account listing and the addition of a new subordinate page are shown in FIG. 8. Clicking on said link, email or banner advertisement may bring up a web form similar in substance to an example user interface shown in FIG. 13. The form can be completed by the Master Account holder alone or together with a Child Dependent. Indeed, the system can be altered such that Child Dependents can first fill out their form and then notification is sent to the Master Account Holder to either approve or disapprove of the account as desired. Other embodiments of the system might prompt people to create Sub Accounts and to submit the relevant Sub Account information via Wireless Devices, standard voice calls, interactive voice response systems, and even regular mail or facsimile forms.

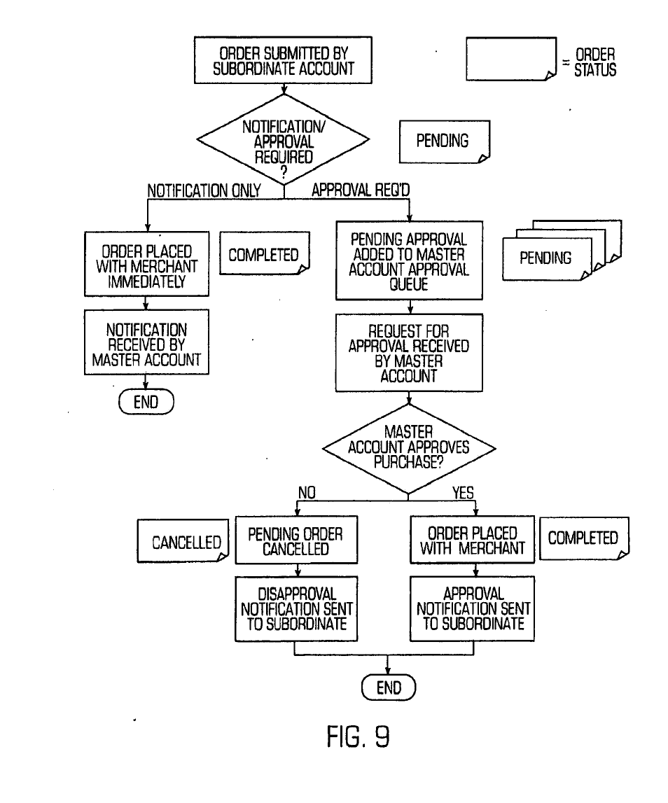

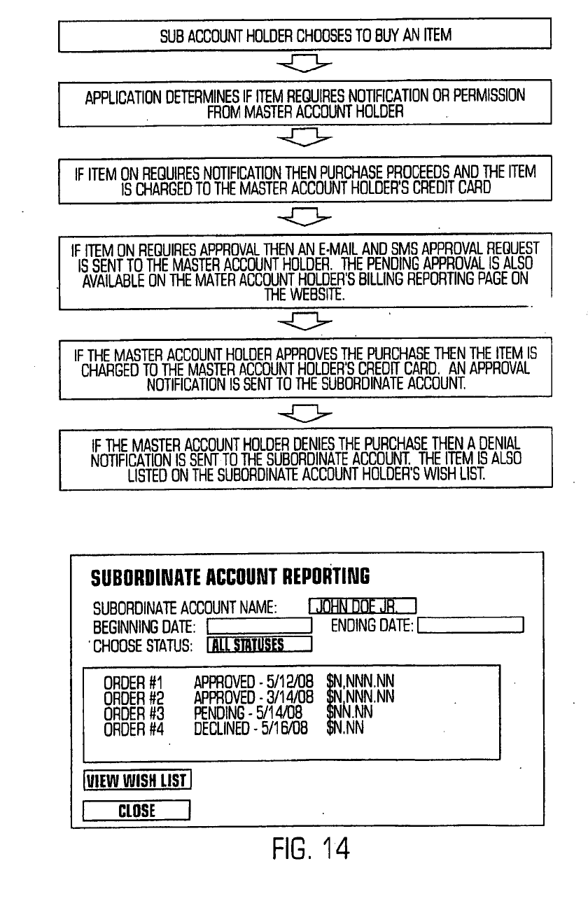

Making Conditional Purchases. Sub Account Holders can ‘conditionally shop’ at the Licensee's website. As illustrated in FIG. 14, a Sub Account Holder visits a Licensee website, finds something he/she may want to purchase, adds the good(s) to an electronic shopping cart, and proceeds to check out. Upon the initialization of the checkout process, the Licensee site recognizes, this purchase is a Conditional Purchase and this user is a Sub Account Holder. An identifier, operatively capable of being indexed, can be used to designate a Sub Account Holder, and therefore, a Conditional Purchase. As an example, Sub Accounts might have unique fields, numbers, or other binary toggles that serve to identify an account as a Sub Account. Sub Accounts can be stored in unique Sub Account tables within the system database server so purchases made by a Sub Account Holder, listed in the table, may be recognized as Conditional Purchases made by a Sub Account Holder. Having identified the purchase as a Conditional Purchase and the account as a Sub Account, the system retrieves and presents a distinct, alternative ‘checkout’ path (the “Sub Account Checkout Path”) as outlined in FIG. 9. The Sub Account Holder is prompted to confirm the good(s), quantity, and ship-to-address. The Sub Account Holder may be prompted to finalize his conditional checkout. In the present exemplary embodiment, the Sub Account Checkout Path may prompt the Sub Account Holder to enter the username and password associated with the Sub Account to confirm the intention to conditionally purchase the good(s) in question. Use of a two factor input, such as a username and password, provide added security and reduce the likelihood of account identifier redundancy and/or confusion.

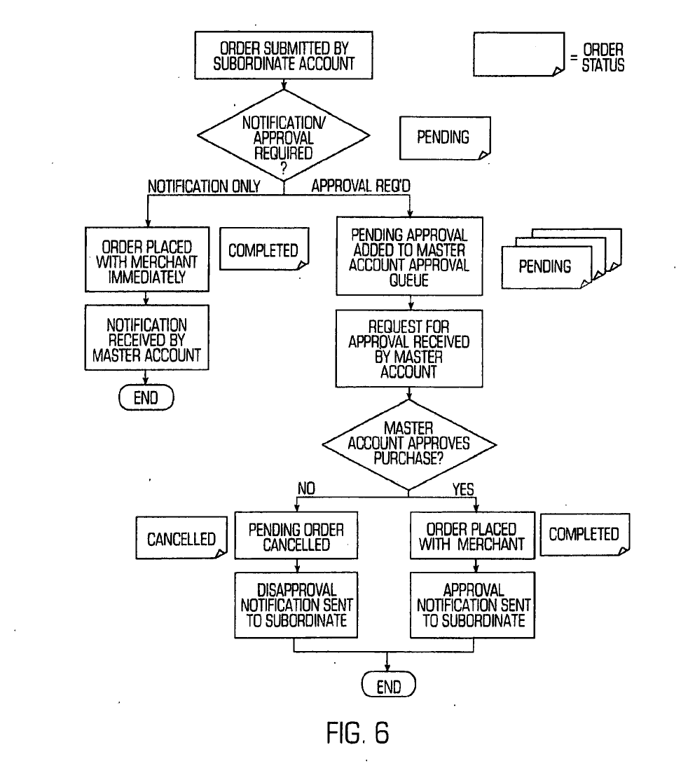

Further to the aforementioned embodiment, successful confirmation of a Conditional Purchase/Transaction by the Sub Account Holder may result in the Conditional Purchase/Transaction being transferred and stored in a pending Conditional Purchase/Transaction order queue as shown in FIG. 6. After confirmation and validation, the Conditional Purchase/Transaction requires Master Account approval. Having confirmed and validated a Conditional Purchase, a database lookup may be performed to identify the Master Account associated with this Sub Account. The Conditional Purchase is approved or disapproved by the Master Account Holder. If approved, the order may be completed using the information preserved in the queue. The queue can include a complete order information snapshot.

Using the corresponding Master Account, the system transmits a notification and request for approval to the Master Account Holder (hereafter, the “Approval Request”). The Approval Request transmits to the Master Account Holder the relevant Conditional Purchase/Transaction information including, but not limited to, the Sub Account and Sub Account Holder who ‘requested’ the Conditional Purchase (note: more than one Sub Account can be associated with a Master Account), the requested purchase item, the merchant, price, the ship-to-address, or any other purchase related information. The Approval Request prompts the Master Account Holder to either approve or disapprove the Conditional Purchase and in so doing, authorize payment for the Conditional Purchase using the preferred Master Account Billing Information associated with said Master Account.

One exemplary method for conveying a Master Account affirmative approval might require the Master Account Holder to respond to the Approval Request by transmitting the PIN or security code associated with said Master Account back to the system such that the system can perform a database lookup to corroborate the PIN against the PIN of record contained in the Master Account Holder's Master Account. Other codes, PINs or methods of approval can be utilized.

Having established a positive match against the record in the Master Account, the system finalizes the transaction. The Master Account Holder's Billing Information is submitted via the Licensee's payment processor for approval. Approval (or denial) is authorized by such payment processor, and the Conditional Purchase/Transaction paid for. The Conditional Purchase (now an actual purchase) is processed pursuant to the instructions as contained in the original Conditional Purchase order. The system can transmit final disposition information to both the Master Account and Sub Account Holders notifying them of purchase details using communication methods comprising e-commerce, text messaging, fax, voice, or interactive voice response protocols. An example of the subordinate account user interface at a licensor's web site is shown in FIG. 14.

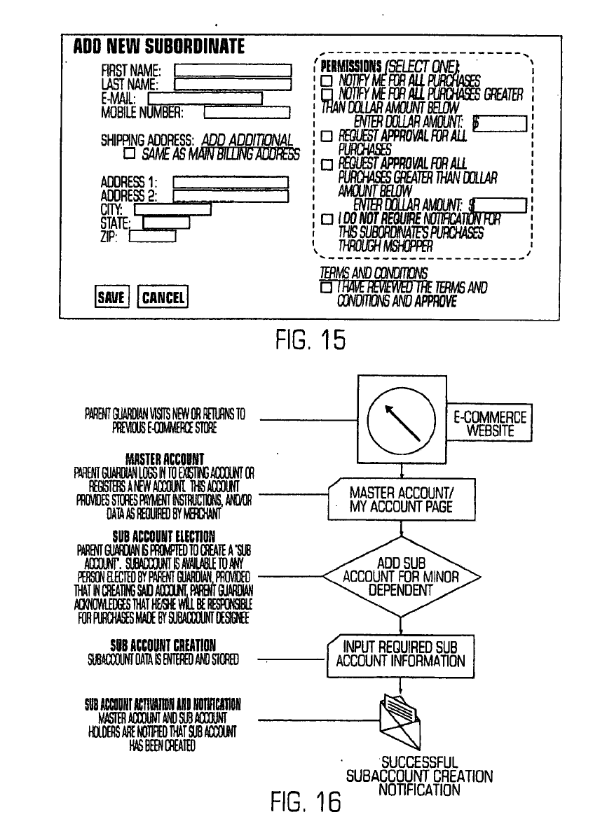

Alternative embodiments of the invention would allow Master Account Holders to require real-time approval for any or all Conditional Purchase/Transactions associated with one or more Sub Accounts. Other embodiments would allow Master Account Holders to pre-program authorization and denial rules for any particular Sub Account as illustrated in FIG. 15. As an example, the Sub Account of a teenager can be programmed to approve any Conditional Purchase less than $10 (Master Account Holders might initially, or by default, deny the Conditional Purchase of an individual Sub Account Holder)

The system can optionally provide for the acceptance of proactive denials transmitted back to the system that unambiguously denies the approval of the Conditional Purchase. Alternatively, the system can be programmed to ‘time out’ any Approval Request such that if the Master Account Holder does not transmit an authorization response to the Approval Request within a prescribed period of time, the Approval Request may be denied and the Conditional Purchase is not effectuated.

In circumstances where Approval Requests might be denied, the system can easily provide archiving of denied Conditional Purchases in a ‘wish list’ allowing a Master Account Holder to purchase the item(s) at a later, more advantageous time. A Sub Account Holder might re-submit the same conditional purchase for further consideration.

Inbound and outbound communications between the system, Master Account Holders and Sub Account holders can be transmitted across any wireline or wireless networks and any media compatible with said networks, including email, text messaging, interactive voice response systems, and even standard voice or voice over internet protocol technologies can be effectively used as transmission media. The proliferation of cell phones, personal digital assistants, wireless computers, smart phones and other wireless devices, amongst Minor Dependents and Parent or Guardians can be used in or near traditional ‘brick and mortar’ store environments. With the method and system described herein, wireless device enabled Minor Dependents located in or near traditional, ‘brick and mortar’ based retailers (retailers occupying actual physical retail space), can use wireless devices to access real-time price comparison and fulfillment services and may check out using a wireless system to execute their Conditional Purchase. This may include contactless checkout utilizing NFC, as provided by carrier services. As an example, a Parent or Guardian might register a Master Account and one or more Sub Accounts with a mobile price comparison application. A Sub Account Holder might use his/her Wireless Device to price compare an item they see in a store and then conditionally purchase the item through a wireless application. The Conditional Purchase checkout by the Sub Account Holder may prompt for the security code associated with a Sub Account. A two factor security algorithm, one using two inputs to confirm a user's identity, might correlate the Sub Account security code with the Sub Account Holder's mobile number of record. The system might then process the Conditional Purchase in a manner, such that, Approval Requests could be simultaneously transmitted to the Master Account Holder's email address and via a text message sent to the Master Account Holder's cell phone of record. Having received a text message Approval Request, the Master Account Holder can approve or deny the Conditional Purchase by transmitting a text message response containing an appropriately formatted security code.

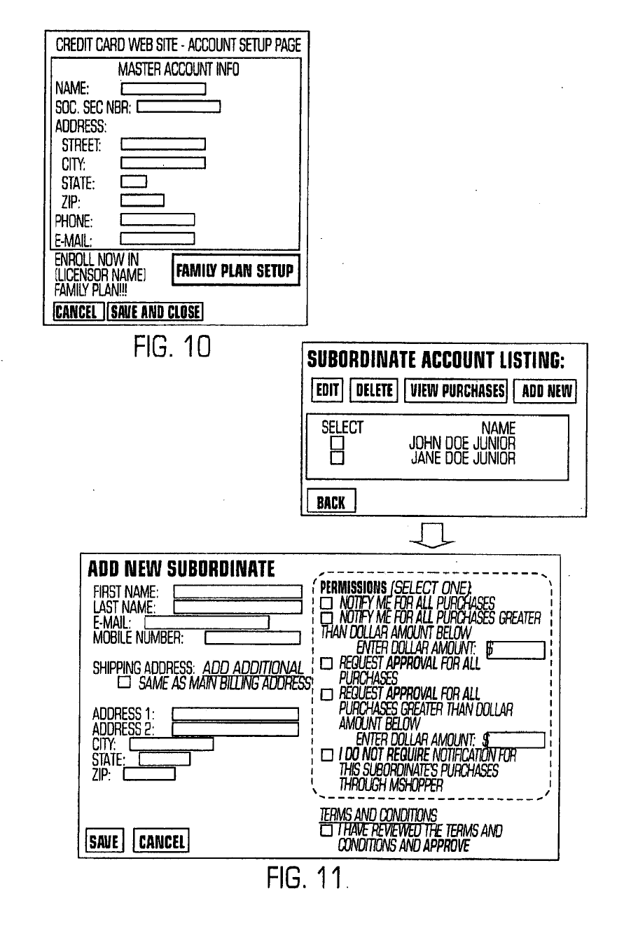

In another embodiment, there exist a method and system for providing use of Conditional Purchase Cards. The vast majority of purchases are made in traditional ‘brick or mortar’ retailer environments. Because many Minor Dependents spend their leisure time at shopping malls and plazas hosting retailers, there is a high likelihood they will purchase goods requiring approval from their Parent or Guardian. Licensees, such as the major credit card companies, such as American Express, Discover, MasterCard, Visa, Barclay's may promote existing or new applicants to add Sub Accounts to their existing credit card account, providing Minor Dependents or other Sub Account holders the opportunity to make use of a Conditional Purchase Card. Sub Accounts can be added using paper, electronic, or even interactive voice response (IVR) methodologies. A “Conditional Purchase Card” can be issued in the name, and for the benefit of, the Sub Account Holder. Examples of the credit card company screens for establishing accounts and subordinate accounts are shown in FIGS. 10-11. The Sub Account Holder can visit a store of his or her choosing that accepts the brand of credit card associated with the Master Account (and Sub Account). The clerk processes the Conditional Purchase. The system, having recognized the card number as a Conditional Purchase Card, would prompt the clerk to ‘hold’ the package until final authorization is received. An Approval Request is transmitted to the Master Account Holder using a transmission media, such as the web, wireless or the like. The Master Account Holder transmits approval (or disapproval) of the Conditional Purchase back to the system for final processing. If approval is given, the Master Account Billing Information is authorized and notice is sent back to the merchant and to the Sub Account Holder.

Description of a Conditional Purchase System

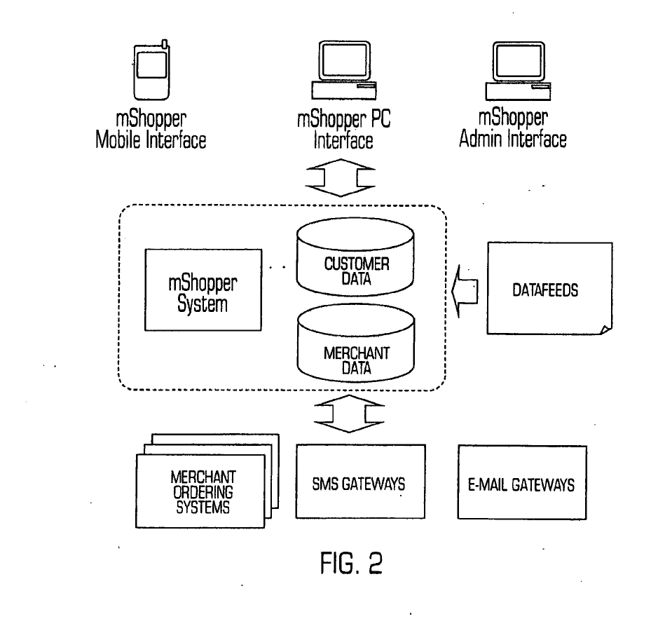

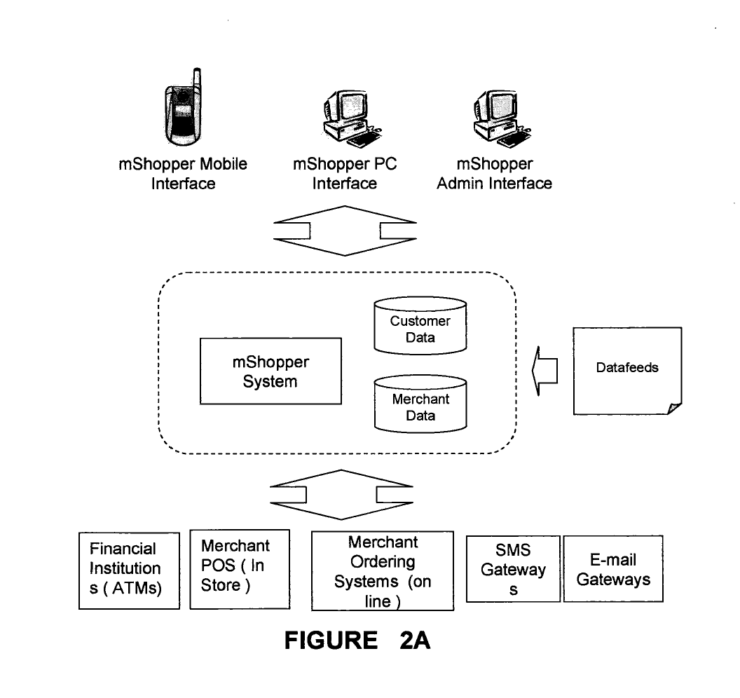

In one embodiment, the system (an example of which is shown in FIG. 2) comprises a customer user interface, one or more databases, one or more servers and several software application modules which may comprise, an accounts module, an ordering module, a fulfillment module, a customer tracking module, a security module that controls access to the master account and sub-accounts, an auditing module and an accounting module which may all be implemented in software (a plurality of lines of computer code) in one embodiment. The one or more system databases may comprise a registered users database, which may include all Master Accounts and related Sub Accounts, with all related data. The system may also include logic governing the actions between a Master Account and all related Sub Accounts, such as approval thresholds. Such thresholds may be dynamic. Furthermore, the approval may be category based meaning that the master account may require purchase approval for certain types of items. Furthermore, the approval may be behavior based, based on stored behavior history. Furthermore the approval may be time or location based, to add further layers of filtering. The accounts module handles the master and sub accounts, registration of the master and sub accounts and the logic governing the actions between the master accounts and the sub accounts. The system may comprise an open application programming interface (“API”) providing streamlined integration into existing electronic commerce, mobile commerce, or brick and mortar applications. A system in accordance with the present invention should be highly flexible to accommodate the differing needs of Licensors, Purchasers, Master Account holders, Sub Account holders and merchants and may be offered as Software as a Service (SaaS). System components can be hardware independent, allowing the interchangeability of the computer hardware on which the server software operates. The components comprising the system may reside in the same physical location, such as on the same computer hardware, or may be located in separate physical locations or may be a hybrid.

In the aforementioned embodiment, the interface can be a menu-driven interface for the input of descriptive information relating to the Metadata, such as provided by a graphical user interface (GUI). Data can be entered into fields provided on the interface; wherein the fields are arranged to aid the user. Input can be gathered from a standard cell phone keyboard, a modern keyboard layout, such as a “QWERTY” compatible keyboard, or using existing interactive voice recognition (IVR) technologies. Metadata can be transmitted via a standard phone call which may be answered by automated or manned systems, such as a call center.

Further to the embodiment, the potential purchaser can use a keypad on a communications device, such as for example, a Dual-Tone Multi Frequency (DTMF) device, to input the descriptive information about the product and/or service when formulating the product or service comparison query. The potential purchaser can also use speech Interactive Voice Response (IVR) to input the descriptive information about the goods and/or service. For example, the potential purchaser can be provided with a speech Interactive Voice Response customer user interface that prompts the purchaser for descriptive information. The speech Interactive Voice Response customer user interface may be written in VoiceXML or SALT and use Microsoft Speech Server software residing on server hardware, such as for example Intel architecture machines. In another example, the purchaser can use the keypad on a mobile phone, or touchpad on a smart phone, to compose a text message containing the descriptive information about the product and/or service, which can be sent as the query. Furthermore, the descriptive information about a product or service can be entered into the query using Automatic Speech Recognition (ASR), such as that provided by Nuance, Inc. In such a case, a telephone caller can use his/her own voice to speak the descriptive information about a product and/or service to supplement or obviate the use of a keypad. Wireline as well as Mobile telephone callers can make full use of the system via Automatic Speech Recognition without having to press telephone keys.

In another embodiment, the descriptive information about a product and/or service can be entered into the customer user interface using a bar code scanner, whereby the item's bar code is input by a scanning process. A purchaser may wish to compare prices on a single product or service. Similarly, the descriptive information about the product and/or service can be entered into the query by receiving information contained in a Radio Frequency Identification (RFID) tag, which contains the descriptive information about the product and/or service in an electronic form readable by a Radio Frequency Identification transceiver. The Radio Frequency Identification transceiver that receives the descriptive information about the product and/or service can, for example, be embedded into the potential purchaser's communications device (such as a cell phone).

In another embodiment, the customer user interface may be located remotely from the potential purchaser. The purchaser may contact a call-center and speak with an agent, who inputs the descriptive information about a product or service into the customer user interface based on the potential purchaser's instructions. Also, where the customer user interface is located remotely from the potential purchaser, any of the above-described methods for entering descriptive information about the product and/or service (electronic forms, OCR, ASR, etc.) can be used.

Transmissions to and from the system are carried via a communications link. The communications link can be, without limitation, any existing or future wireless or wireline Internet, wireless or wireline data network, wireless or wireline voice network, or wireless or wireline data or voice technology that can be used to transmit the metadata as inputted by the consumers to the centralized servers and databases. Wireless data can be transmitted using existing cell phone companies as distribution intermediaries. The communications link may provide passing of the metadata from the user's cell phone through the carriers' networks and related systems, and into the servers and databases.

The one or more databases and one or more servers may be centralized or disseminated or a network and may be designed to manage the entire system including receiving the incoming metadata or query from the communications link, processing the query using an appropriate price or product comparison search technology, and handling reverse auction requests. Furthermore the databases may include all details for registered users, Master Account and Sub Account holders, as well as detailed transaction history, and all related logic. The hardware may be configured to work with operating systems, such as the Linux operating system, and servers, such as the Hewlett-Packard Blade server. Server software, such as Apache server software, may be configured to implement the one or more databases managed by software, such as mySQL database software. The LAMP Framework (Linux, Apache, mySQL, PHP, Python, PERL) is preferably used for application development. Websites hosted on the one or more databases and one or more servers may run server software, such as Microsoft IIS server software. The price or product comparison engine can comprise Internet based price or product comparison shopping engines, such as PriceGrabber or ShopZilla, or the price or product comparison engine may be a proprietary module. The system may include a method for transferring appropriately formatted metadata to such outsourced comparison engine and for receiving query results from the same outsourced comparison engine. The transfer of such appropriately formatted metadata to the outsourced comparison engine and the receipt of any price or product comparison data from the outsourced comparison engine may be effected via any existing or future data transmission network, including an electronic data interface, a virtual private network, or the internet, formulating and formatting a response to the query (the “price comparison data result” or “product comparison data result”).

In response to the price comparison data result or product comparison data result, the customer may decide to purchase the product in question from one of the retailer alternatives presented in the price comparison data result or product comparison data result (as opposed to purchasing the product from the retail store in which the consumer may then be located at the time he/she initiated the query). In such instances, the system would provide for the real time or near real time ordering of such product through such alternative retailer or supplier. Any ordering and fulfillment requested by the consumer can be effectuated by prompting the consumer to input all the relevant purchasing information (billing, shipping, etc.), by accessing customer information pre-stored on a customer account database, or by automatically directing such consumer to a remote call center which may then act as an agent to input the same relevant purchasing information on his/her behalf. Where a call center is used, the system can automatically transmit the metadata and vendor or supplier of choice as selected by the consumer to such call center in order to automate and streamline the order process.

The customer may decide not to purchase a product or service in response to a price or product comparison query. In such a case, the system can give the customer the opportunity to receive information contained within the price or product comparison result via SMS and/or e-mail, preferably the top three merchants. The system can prompt the customer to input an e-mail address or can access a customer account database to determine whether the customer has stored an e-mail address. The system can then e-mail the price or product comparison information to the customer's e-mail address

The price or product comparison data result can include the amount of money the customer has saved through conducting a price or product comparison query. The customer can be prompted to donate some or all of the amount saved to one or more of the customer's favorite charities. The system allows the customer to identify and store the one or more favorite charities on a customer account database. When the customer donates an amount of savings to a charity, the system transmits the information necessary to effect the donation (such as a credit card number) to the charity and also transmits a donation confirmation to the customer's communications device. The system can include one or more product catalog database(s), which store information relating to products and/or services and are searched in response to a customer query. The product catalog database(s) may reside along with other components of the centralized databases and servers or be located remote from them. Where the product catalog database resides within the centralized databases and servers, the information relating to products and/or services can be populated and/or updated via an automatic process, wherein the system accesses merchant databases or websites and downloads information from them. Populating or updating the product catalog database(s) is done preferably through an automatic ftp or http datafeed from the merchant databases and/or through a web crawler that searches merchant databases or websites on a predetermined list for product and/or service information. The result is a near-real time product catalog database. Furthermore, this product catalog may be improved via data mapping, brand recovery, model recovery and brand normalization. The system can also obtain information relating to products and/or services directly from merchant databases in response to a customer query.

As stated above, the system can include a customer account database that stores information relating to customers using the system. Users can register information in advance, preferably via a registration process at a predefined website, into the customer account database so that the purchasing process can be further streamlined. Information stored on the customer account database can include, for example, names, nicknames, mailing addresses, telephone numbers, e-mail addresses, websites, credit card information, debit card information, gift card information, shipping information, billing information, favorite charities, and any other customer information desired. The system will store such information so that repeat users can quickly effectuate future purchases. This information can be accessed and/or protected by a personal identification number (PIN), security code, or other personal identifier established at the time of registration.

The system can include a transaction database, which stores information relating to all transactions customers have carried out using the system. Information stored on the transaction database can include the product and/or service that was the subject of a price or product and/or service comparison or reverse auction, the date and time of each price or product and/or service comparison carried out, the date and time of each reverse auction carried out, the result of each price or product and/or service comparison and reverse auction, the amount saved in each transaction, the amount donated from the savings in a transaction (if any), and any other information regarding any transaction carried out by users of the system. Furthermore a customizable dashboard into the transaction database can be included, to facilitate queries, by date, price, merchant, user or any other desired parameters. Furthermore this dashboard can provide reporting capabilities, including time filters, and summary reports, by day, week, month, quarter, year, etc.

Reliability. Because of the nature and real time sensitivity of e-commerce transactions, redundancy can be utilized to accommodate fault tolerance, including suspend and resume processes.

Security. All stored and transmitted data can be tracked and encrypted. Multiple layers of security can be further utilized to assure maximum security, including multiple factor authentication (PIN and one time use security code), authorization, and access control, such as those offered by Computer Associates or EMC/RSA.

Given that sensitive customer information is being transmitted via submit order function (customer-payment gateway), in an end to end system, all available security layers as used by credit card processing and payment gateways can be utilized to include https protocol, SSL, encryption, IP validation, Virtual Payer Authentication (VPA), signed request authentication, and fraud detection.

The conditional purchase system and method may be used to convert traditional credit cards, debit cards, stored value cards or merchant credit cards into conditional purchase cards using the system.

When a master account approves an item purchase by a sub-account, the conditional purchase system and method may require the master account holder to respond to the approval request by transmitting a code (encrypted), such as a personal identification number or security code, etc., associated with the master account back to the system such that the system can perform a database lookup to corroborate the code against the code of record contained in the master account holder's master account.

The communications between the master account holder, the sub-account holders and the conditional purchase system may be transmitted across any wireline or wireless networks and any media compatible with said networks, including email, text messaging, interactive voice response systems, and even standard voice or voice over internet protocol technologies can be effectively used as transmission media.

When the sub-account is a minor dependent, the minor dependents are provided an ability to make conditional purchases in a context that is remote from immediate supervision of their Parent or Guardian while simultaneously providing to the Parent or Guardian the ability to monitor and control their Conditional Purchases.

A licensor's website may notify a master account holder to add sub-accounts. The notification can be provided by standard hyperlinks, email, banner advertisements or other medium.

The conditional purchase system may be programmed to ‘time out’ any approval request such that if the master account holder does not transmit an authorization response to the approval request within a prescribed period of time, the approval request may be denied and the conditional purchase is not effectuated. The system may also be used to provide conditional purchase cards.

There is through embodiments described herein, a method and system empowering children, and other financially irresponsible individuals, employees of corporations, large and small, who have been issued corporate cards, with an ability to shop on their own using Electronic Payment/Transaction Media and real-time electronic communications, such as email and text messaging such as SMS while simultaneously conveying real-time control to parents and guardians, corporations, and even county, state and federal governments, in advance of intended purchases/financial transactions by those under their guardianship. By way of embodiments, a method and system is described to provide for the approval and/or disapproval of aforementioned intended purchases/financial transactions. Such methods and systems described have heretofore not been available.

Embodiments are described herein for online e-commerce websites, brick and mortar merchants, mobile commerce sites, financial institutions payment platforms, non-financial institution payment platforms (such as Paypal), credit card associations, and credit card issuing banks, to deploy and offer to customers the conditional purchase/financial transaction methods and systems described herein and hereafter.

Additional embodiments are described herein where conditional purchases/financial transactions may be effectuated via traditional “physical” credit, debit or stored value cards, gift cards, charge cards, within an actual brick and mortar physical establishment.

Yet another embodiment may be a mobile payment service, utilizing cell phones, smartphones, wireless devices, digital wallet technologies, and/or Near Field Communications (NFC) to accomplish contactless payments, or similarly implemented via SMS, MMS or Premium SMS based transactional payments, or Direct Mobile Billing (billed to mobile account), or Mobile Web Payments (WAP). The use of cell phones, smart phones, personal digital assistants, and other handheld electronic devices (collectively “Wireless Devices”), the concurrent deployment of high speed wireless networks that connects such wireless devices, and the growing emergence of mobile commerce applications, can readily provide an end-to-end system that would allow minors, dependents and other people who do not otherwise possess Electronic Payment/Transactions Media (hereafter referred to as “Minor Dependent” or “Minor Dependents” as the case may be) to make Conditional Purchases/Transactions in or near traditional brick and mortar environments, or on eCommerce websites—using their Wireless Devices that is subject to final approval and real-time control by their parents or guardian.

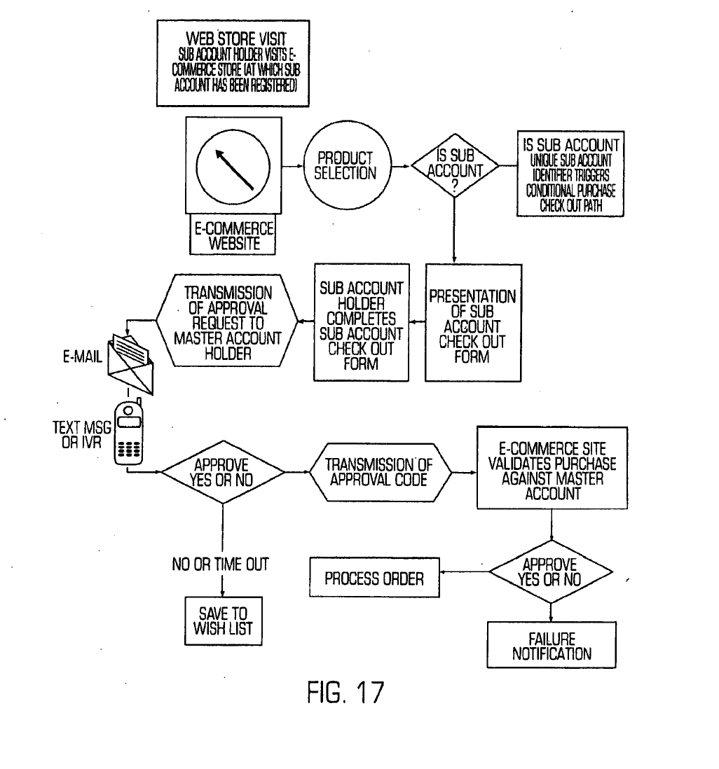

An example of the workflow for creating a minor dependent sub-account is shown in FIG. 16. Furthermore, a purchase process for a minor dependent purchase using a sub-account is shown in FIG. 17. A method and system are provided for the use of traditional credit cards, debit cards or gift cards, or stored-value cards, or charge cards, or mobile contactless payment service, so that Minor Dependents can be issued ‘conditional purchase’ cards associated with their parent's credit, debit or gift cards, or stored-value cards or prepaid credit cards, or ATM cards, such that they too can make purchases, or conduct financial transactions) online or in traditional store environments subject to real time, near real time or time delayed control of their parents. Because the vast majority of retail sales occur in stores and not online (according to U.S. government estimates, more than 95% of 2004 retail sales occurred in stores as opposed to online or through catalogues), the potential market size is significant.

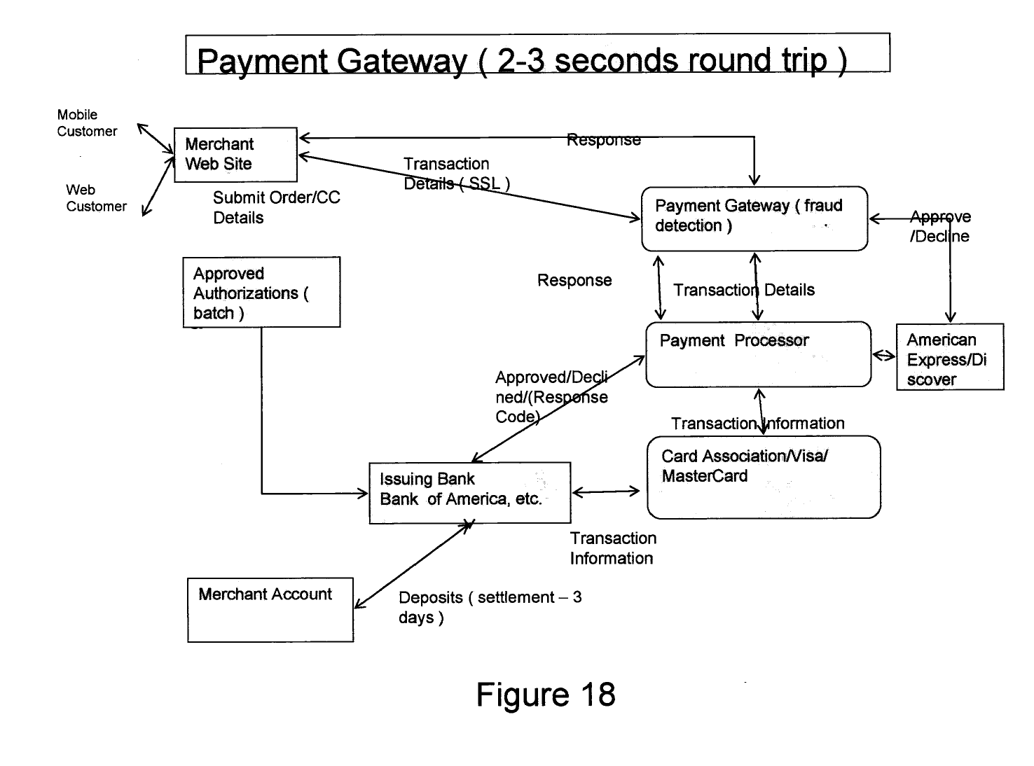

The method and system described herein, as described and shown in FIG. 18, can co-exist within the present and existing payment gateway eco-system and the present financial institution ATM system. Finally, the invention described herein and hereafter may readily exist within the evolving carrier based mobile payment system, utilizing contactless payments, or Premium SMS, or Direct Mobile Billing or Mobile Web Payments (WAP). Because existing payment eco-systems facilitate a majority of purchase or financial transactions, it is desirable to provide a conditional purchase/transaction system and method, that integrates seamlessly with such existing payment system eco-system and financial institution ATM system, and carrier based mobile payment service, and it is to this end that the present invention is primarily but not uniquely directed.

While the foregoing has been with reference to a particular embodiment of the invention, it will be appreciated by those skilled in the art that changes in this embodiment may be made without departing from the principles and spirit of the invention, the scope of which is defined by the appended claims.

1. A system for conditional purchase/transaction, comprising:
one or more stores including a registered users store having one or more master accounts associated with the system and one or more sub-accounts associated with the system, wherein each particular master account is associated with one or more particular sub-accounts;
an ordering module that allows a user to place an order to purchase an item; and
an account module that controls the purchasing of the one more particular sub-accounts associated with the particular master account.

2. The system of claim 1, wherein each store further comprises one or more databases.

3. The system of claim 1, wherein the accounts module further comprises a configurable set of purchasing permissions/transaction permissions for each of the one or more particular sub-accounts wherein the configurable set of purchasing permissions are set by the particular master account, to also include selectable thresholds.

4. The system of claim 3, wherein the configurable set of purchasing permissions/transaction permissions for each of the one or more particular sub-accounts further comprises a permission to complete a purchase of an item or complete a financial transaction, wherein the particular master account approves the purchase of an item by the one or more particular sub-accounts.

5. The system of claim 3, wherein the configurable set of purchasing permissions/financial transaction permissions for each of the one or more particular sub-accounts are different for the one or more particular sub-accounts.

6. The system of claim 5, wherein the configurable set of purchasing permissions/financial transaction permissions for each of the one or more particular sub-accounts further comprises one of no restriction on a purchase of a sub-account, an approval for all purchases of a sub-account, an approval for all purchases greater than a predetermined amount of money for a sub-account, and an approval for certain types of items, and other permutations of approvals to include time, product category, specific merchants, and location.

7. The system of claim 3 wherein the ordering module sends a message to the master account when a particular sub-accounts tries to purchase an item, complete a financial transaction, that requires approval based on the configurable set of purchasing permissions, wherein the message includes an item product name, an item brand name, an item model number, an item price, and an item merchant.

8. The system of claim 7, wherein the message further comprises a link to the item so that the master account holder can view the item/financial transaction and wherein the message facilitates master account approval or disapproval response.

9. The system of claim 1, wherein the ordering module, if the particular master account approves an item purchase/financial transaction by the particular sub-account, initiates an order for the item including a notification to the particular sub-account that the purchase has been approved and charging the master account for the item purchase.

10. The system of claim 1, wherein the accounts module further comprises a new user registration module.

11. The system of claim 3, wherein the account module further comprises an account administration module that allows the particular master account to change the configurable set of purchasing permissions/financial transaction permissions for each of the one or more particular sub-accounts and that allows each sub-account to view the configurable set of purchasing permissions/financial transaction permissions for that sub-account.

12. The system of claim 1 further comprising a security module that controls access to the particular master account and one or more particular sub-accounts using multiple factor user authentication.

13. The system of claim 1, wherein the account module allows the particular master account to create a new sub-account, modify an existing sub-account and delete a sub-account.

14. The system of claim 3, wherein the account module further comprises a wish list for each of the one or more particular sub-accounts wherein items whose purchase is not allowed by the particular master account are placed into the wish list.

15. The system of claim 1, wherein the account module further comprises a master account approval module to approve an item purchase/financial transaction by a sub-account wherein the approval of the item requires the particular master account to submit an encrypted unique identification code to verify the particular master account holder.

16. The system of claim 15, wherein the code further comprises one of an encrypted personal identification number and a security code.

17. The system of claim 1 further comprising a conditional purchase/financial transaction unit that houses the one or more stores, the ordering module and the account module, a computing device associated with the particular master account, a computing device associated with each of the one or more particular sub-accounts and a link that is capable of connecting the conditional purchase unit and the computing devices to each other wherein the link is a wireline link or a wireless link.

18. The system of claim 1, wherein the account module times outs a request for the approval of an item purchase/financial transaction if the particular master account does not approve the item purchase/financial transaction within a predetermined amount of time.

19. A computer implemented method for conditional purchase/transaction, comprising:
storing, in a registered users store, one or more master accounts associated with a conditional purchase system and one or more sub-accounts associated with the conditional purchase system, wherein each particular master account is associated with to one or more particular sub-accounts;
placing, using an ordering module, an order by a user to purchase an item; and
controlling, using an account module, the purchasing of the one more particular sub-accounts associated with the particular master account.

20. The method of claim 19, wherein each store further comprises one or more databases.

21. The method of claim 19 further comprising providing a configurable set of purchasing permissions/financial transacting permissions for each of the one or more particular sub-accounts wherein the configurable set of purchasing permissions are set by the particular master account.

22. The method of claim 19 wherein sub accounts can make conditional purchases/transactions using online accounts, cell phones or mobile-accessed accounts, or ‘conditional transaction’ accounts that are accessed using the equivalent of credit, debit, stored value cards, charge or ATM cards or utilizing a mobile payment system, which uses a swipe and go approach, with NFC and a mobile device, or Premium SMS, or Direct Mobile Billing, or mobile web payments (WAP).

23. The method of claim 21, wherein the configurable set of purchasing permissions/transaction permissions for each of the one or more particular sub-accounts further comprises a permission to complete a purchase of an item, complete a financial transaction, wherein the particular master account approves the purchase of an item, or the financial transaction, by the one or more particular sub-accounts.

24. The method of claim 21, wherein the configurable set of purchasing permissions/transactions for each of the one or more particular sub-accounts are different for the one or more particular sub-accounts.

25. The method of claim 24, wherein the configurable set of purchasing permissions/transactions for each of the one or more particular sub-accounts further comprises one of no restriction on a purchase or financial transaction of a sub-account, an approval for all purchases/financial transactions, of a sub-account, an approval for all purchases/financial transactions less than a predetermined amount of money for a sub-account, and an approval for certain types of items.

26. The method of claim 19, wherein controlling the purchasing of the one more particular sub-accounts associated with the particular master account further comprises notifying, when a sub-account attempts to purchase an item, complete a financial transaction, the particular master account that the sub-account is attempting to purchase an item, complete a financial transaction, wherein the notification further comprises item information.

27. The method of claim 26, wherein the item information further comprises an item product name, an item brand name, an item model number, an item price and an item merchant, or complete details of a proposed financial transaction.

28. The method of claim 24, wherein notifying the particular master account further comprises sending a message to the particular master account.

29. The method of claim 28, wherein the message further comprises one of an email message and a short message system message, multi-media message system, or voice call via any telephony or VOIP network.

30. The method of claim 28, wherein the message further comprises a link that allows the particular master account to view the item the sub-account wants to purchase, or the details of a financial transaction that the sub-account wants to complete.

31. The method of claim 19 further comprising initiating an order of the item when the particular master account approves the item purchase by the sub-account, or initiating an approval of a financial transaction when the particular master account approves the financial transaction by the sub-account.

32. The method of claim 31, wherein initiating the order of the item further comprises sending a notification to the sub-account that the item purchase has been approved and charging the item purchase to the particular master account, or that the financial transaction has been approved and completed.

33. The method of claim 19 further comprising registering a user as a master account.

34. The method of claim 19 further comprising providing accounts administration wherein the particular master account edits the permissions of the sub-accounts and views the purchase history for the master account and the related sub-accounts and wherein each sub-account can view the set of permissions of the sub-account and view of the purchase history of the sub-account.

35. The method of claim 19 further comprising validating access to the particular master account and the sub-accounts using multiple factor user authentication.

36. The method of claim 34, wherein providing accounts administration further comprises permitting the particular master account to one of adding new sub-accounts, modifying existing sub-accounts and deleting sub-accounts.

37. The method of claim 19 further comprising placing, if an item or a financial transaction is not approved by the particular master account for a sub-account, an item/financial transaction on a wish list for the sub-account.

38. The method of claim 19 further comprising validating an approval of an item purchase/financial transaction by the sub-account by the master account.

39. The method of claim 38, wherein validating the approval of an item purchase/financial transaction further comprises providing a code by the particular master account to validate the master account.
